(19) United States
(12) Patent Application Publication
(10) Pub. No.: US 2025/0190335 A1
(43) Pub. Date: Jun. 12, 2025

(54) CODE DETECTION METHOD AND APPARATUS, ELECTRONIC DEVICE, AND STORAGE MEDIUM

(71) Applicant: Lemon Inc., Grand Cayman (KY)

(72) Inventor: Junyu YUE, Beijing (CN)

(21) Appl. No.: 18/977,643

(22) Filed: Dec. 11, 2024

(30) Foreign Application Priority Data
Dec. 11, 2023 (CN) 202311698092.0

(51) Int. Cl. G06F 11/3668; G06F 8/41; G06F 11/362

(52) U.S. Cl. CPC G06F 11/3692; G06F 8/427; G06F 11/3624

(57) ABSTRACT

Embodiments of the present disclosure provide a code detection method and apparatus, an electronic device, and a storage medium. The method includes: loading code to be detected; obtaining, through a class loader, first class information of the code to be detected; and performing code detection on the code to be detected based on class information of the code to be detected, to obtain a detection result of the code to be detected, where the class information includes the first class information.

### CROSS-REFERENCE TO RELATED APPLICATION(S)

This application claims priority to Chinese Application No. 202311698092.0 filed on Dec. 11, 2023, the disclosure of which is incorporated herein by reference in its entity.

### FIELD

Embodiments of the present disclosure relate to the field of computer technologies, and in particular, to a code detection method and apparatus, an electronic device, and a storage medium.

### BACKGROUND

Currently, static detection is generally used to test code. However, when static detection is used to test code, there are often problems such as inability of a version of a detection tool to be aligned with that of a programming language and inconsistency between a detection environment and an actual compilation environment of the code, resulting in low accuracy of code detection results.

### SUMMARY

Embodiments of the present disclosure provide a code detection method and apparatus, an electronic device, and a storage medium, to improve the accuracy of code detection results.

According to a first aspect, an embodiment of the present disclosure provides a code detection method. The method includes:
loading code to be detected;
obtaining, through a class loader, first class information of the code to be detected; and
performing code detection on the code to be detected based on class information of the code to be detected, to obtain a detection result of the code to be detected, where the class information includes the first class information.

According to a second aspect, an embodiment of the present disclosure further provides a code detection apparatus. The apparatus includes:
a first loading module configured to load code to be detected;
a first obtaining module configured to obtain, through a class loader, first class information of the code to be detected; and
a detection module configured to perform code detection on the code to be detected based on class information of the code to be detected, to obtain a detection result of the code to be detected, where the class information includes the first class information.

According to a third aspect, an embodiment of the present disclosure further provides an electronic device. The electronic device includes:
one or more processors; and
a memory configured to store one or more programs, where
the one or more programs, when executed by the one or more processors, cause the one or more processors to implement the code detection method described in the embodiments of the present disclosure.

According to a fourth aspect, an embodiment of the present disclosure further provides a computer-readable storage medium having a computer program stored thereon. The program, when a processor is executed, causes the code detection method described in the embodiments of the present disclosure to be implemented.

According to the code detection method and apparatus, the electronic device, and the storage medium provided in the embodiments of the present disclosure, the code to be detected is loaded; the first class information of the code to be detected is obtained through the class loader; and the code detection is performed on the code to be detected based on the class information of the code to be detected, to obtain the detection result of the code to be detected, where the class information includes the first class information.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a code detection method according to an embodiment of the present disclosure;

FIG. 2 is a schematic flowchart of another code detection method according to an embodiment of the present disclosure;

FIG. 3 is a block diagram of a structure of a code detection apparatus according to an embodiment of the present disclosure; and

FIG. 4 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

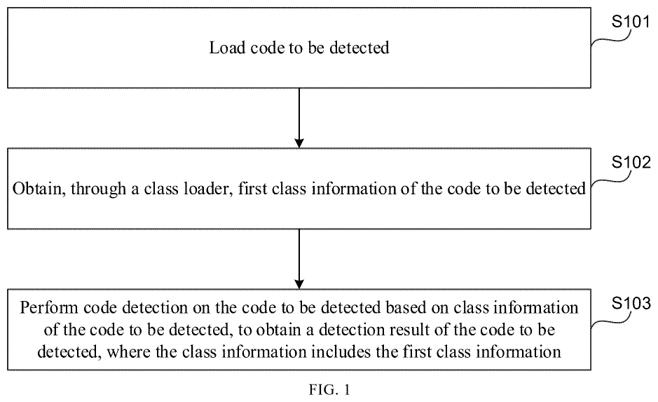

FIG. 1 is a schematic flowchart of a code detection method according to an embodiment of the present disclosure. The method may be performed by a code detection apparatus. The apparatus may be implemented by software and/or hardware, and may be configured in an electronic device, typically, in a computer. The code detection method provided in this embodiment of the present disclosure is applicable to a scenario where code detection is performed, such as a scenario where static detection is performed on code based on a code reflection mechanism.

Static detection is a common tool for scanning code. In static detection, code does not need to be run, and structural information of the code can be obtained and analyzed only based on a source code file or a product file of the code. For example, static detection can automatically scan and fix vulnerabilities in the code, automatically refactor the code, and/or scan and standardize a code format.

Conventional static detection is generally implemented in the following manner: scanning for the source code, where this manner requires converting the source code into an abstract syntax tree (AST), which is then traversed for analysis; or, scanning for intermediate or final products, where this manner requires obtaining products after compilation is completed and perform binary analysis on the products, this is because sometimes it is required not only to analyze the source code, but also to detect some binary dependencies. Such detection is usually used to analyze security vulnerabilities in binary products.

Static detection usually does not require running the entire application to which the code to be detected belongs, usually has a small resource occupation and a fast operation speed, and can even provide real-time prompting in an integrated development environment (IDE) in many cases. However, when static detection is performed for source code, there are often problems such as inability of a version of a detection tool to be aligned with that of a programming language used and inconsistency between a detection environment and an actual compilable and executable environment. The environment is complex to build and cannot necessarily be consistent with actual operating conditions.

In view of this, an embodiment of the present disclosure provides a code detection method, where an introspection mechanism (i.e., a reflection mechanism) in mainstream object-oriented programming languages is used to implement code detection. With this mechanism, an object structure is read, for example, to obtain object information (such as a number of methods and a number of attributes in the object, and a method body) and/or obtain an object type, and then related detection is performed. A code scanning mechanism based on the code introspection mechanism is different from conventional static code scanning that relies on a compiler front-end. The code scanning is performed during runtime (for example, during a loading stage of a running process), but the static information in the runtime (that is, the structural information of the object) is obtained, thus avoiding the problem of inconsistency between a conventional static scanning tool and environment and an actual compilation environment of code.

As shown in FIG. 1, the code detection method provided in this embodiment may include the following steps.

S101: Load code to be detected.

The code to be detected may be understood as code that currently needs to be detected, such as code that needs to be detected to determine content corresponding to a preset detection condition.

In this embodiment, the code to be detected may be obtained and loaded, for example, the code to be detected is loaded into a memory of an electronic device on which a current application program (such as a code detection program) is installed, so that a class loader can parse the code to be detected.

In some implementations, an executable file of the code to be detected may be obtained, and code content of the code to be detected that is recorded in the executable file may be loaded into the memory. In this case, optionally, the loading code to be detected includes: obtaining the executable file of the code to be detected, where the executable file records the code content of the code to be detected; and loading the code content of the code to be detected into the memory.

The executable file may be an executable file that records the code content of the code to be detected. The executable file records the code content of the code to be detected, but is not limited to the code content of the code to be detected. For example, when the code to be detected needs to be detected, the code content of the code to be detected that is recorded in the executable file can be loaded into the memory, so as to subsequently obtain, based on the loaded code content of the code to be detected, the first class information of the code to be detected. There is no limitation on a manner of obtaining the executable file. For example, the executable file of the code to be detected can be stored in advance in the electronic device on which the current application program is installed. In this way, the current application program can obtain, locally from the electronic device on which it is installed, the executable file of the code to be detected.

It should be noted that, in this embodiment, the code to be detected may be simply loaded into the memory, without calling an entry function of the code to be detected to run the code to be detected. In other words, in this embodiment, static detection may be performed on the code to be detected.

S102: Obtain, through the class loader, the first class information of the code to be detected.

The class loader may be used to obtain the class information of the code to be detected. A type of the class loader is not limited. For example, the class loader may be ClassLoader or ClassPath. The first class information may be understood as class information of a class contained in the code to be detected that is obtained through the class loader. The class information may include, for example, a class name, a class type, a class constructor, a class attribute, a class method or function, a class statement, and/or a class parameter, which may be set in advance according to detection requirements.

For example, after the code content of the code to be detected has been loaded, the class information (i.e., the first class information) of the code to be detected may be obtained through the class loader based on the reflection mechanism. For example, the class information of the code to be detected may be obtained through a preset application programming interface (API) of the class loader.

In this embodiment, an information form of the class information obtained through the class loader is not limited. In some implementations, the class loader may obtain class information recorded in a binary code form. In this case, optionally, the obtaining, through the class loader, the first class information of the code to be detected includes: generating, through the class loader, a binary code file corresponding to the code to be detected, where the binary code file is used to record the first class information of the code to be detected in a binary code form.

For example, the class information of the code to be detected in a binary code form may be obtained through the class loader, and the class information in a binary code form may be recorded in the binary code file, thereby obtaining the binary code file of the code to be detected. The binary code file may be understood as a bytecode file, which may record information in a binary code form. In other words, the file content of the binary code file is recorded in a binary code form.

In the above implementation, after the binary code file of the code to be detected is obtained, the class information recorded in the binary code file and presented in a binary code form may be further converted into class information in a non-binary code form to facilitate code detection on the code to be detected. For example, the binary code file of the code to be detected may be loaded into the memory, the file content of the binary code file may be read, and the file content may be parsed to obtain the first class information of the code to be detected that is presented in a non-binary code form. In this case, optionally, after the obtaining, through the class loader, the first class information of the code to be detected, the method further includes: loading the binary code file into the memory; and reading the file content of the binary code file and parsing the file content to obtain the first class information of the code to be detected.

In the above implementation, the manner of reading the file content of the binary code file and parsing the file content of the binary code file may be set as needed. Optionally, the reading the file content of the binary code file and parsing the file content to obtain the first class information of the code to be detected includes: reading, based on a reflection mechanism, the file content of the binary code file by using an application programming interface corresponding to the reflection mechanism, and parsing the file content to obtain the first class information of the code to be detected; or reading the file content of the binary code file by using a preset binary code modification tool, and parsing the file content to obtain the first class information of the code to be detected. For example, the file content of the binary code file may be read through the application programming interface corresponding to the reflection mechanism and/or the preset binary code modification tool, and the file content of the binary code file may be parsed. The preset binary code modification tool may be a preset binary code modification tool, such as ASM.

S103: Perform code detection on the code to be detected based on class information of the code to be detected, to obtain a detection result of the code to be detected, where the class information includes the first class information.

Specifically, after the class information of the code to be detected is obtained, code detection may be performed on the code to be detected based on the class information, for example, to detect and determine content in the code to be detected that meets a preset detection condition, so as to generate a detection result of the code to be detected.

In this embodiment, the class information of the code to be detected may include the first class information, and may or may not include second class information. In order to further improve the accuracy and comprehensiveness of the detection result and a code detection speed, optionally, the class information further includes the second class information, and the second class information and the first class information are obtained in different manners.

The second class information may be class information of the code to be detected that is obtained in a manner different from that of the first class information. For example, the first class information may be obtained based on the reflection mechanism through the class loader. The second class information may be obtained in other manners other than the manner using the class loader. For example, the other manners may be a manner in other static detection methods that are not based on the reflection mechanism, which is not limited in this embodiment.

In some implementations, the second class information of the code to be detected may be obtained based on source code of the code to be detected. In this case, optionally, before the performing code detection on the code to be detected based on class information of the code to be detected, the method further includes: obtaining a source code file of the code to be detected, and generating an abstract syntax tree corresponding to the source code file; and parsing the abstract syntax tree to obtain the second class information of the code to be detected.

For example, the source code file of the code to be detected may be first obtained, and the source code of the code to be detected that is recorded in the source code file may be converted into an abstract syntax tree. Then, the abstract syntax tree is traversed for analysis to obtain the class information of the code to be detected, that is, the second class information.

In the above implementation, a manner of obtaining the source code file of the code to be detected is not limited. For example, the source code file of the code to be detected can be stored in advance in the electronic device on which the current application program is installed. In this way, the current application program can obtain, locally from the electronic device on which it is installed, the source code file of the code to be detected.

According to the code detection method provided in this embodiment, the code to be detected is loaded; the first class information of the code to be detected is obtained through the class loader; and the code detection is performed on the code to be detected based on the class information of the code to be detected. to obtain the detection result of the code to be detected, where the class information includes the first class information. In this embodiment, the above technical solution can be used, in which the class information of the code to be detected is obtained through the class loader to perform the code detection on the code to be detected, to overcome the problem of inconsistency between a detection environment and an actual compilation environment of code in a conventional static detection method, and improve the comprehensiveness and accuracy of code detection results.

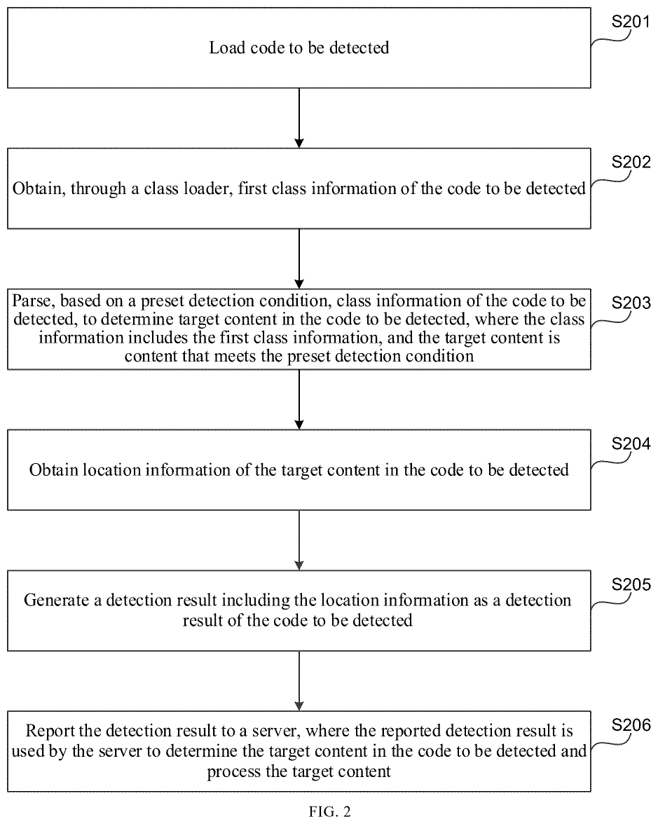

FIG. 2 is a schematic flowchart of another code detection method according to an embodiment of the present disclosure. The solution in this embodiment may be combined with one or more optional solutions in the above embodiment. Optionally, the performing code detection on the code to be detected based on class information of the code to be detected, to obtain a detection result of the code to be detected includes: parsing the class information based on a preset detection condition, to determine target content in the code to be detected, where the target content is content that meets the preset detection condition; obtaining location information of the target content in the code to be detected; and generating a detection result including the location information as the detection result of the code to be detected.

Optionally, after the obtaining a detection result of the code to be detected, the method further includes: reporting the detection result to a server, where the reported detection result is used by the server to determine the target content in the code to be detected and process the target content.

As shown in FIG. 2, the code detection method provided in this embodiment may include the following steps.

S201: Load code to be detected.

S202: Obtain, through a class loader, first class information of the code to be detected.

S203: Parse, based on a preset detection condition, class information of the code to be detected, to determine target content in the code to be detected, where the class information includes the first class information, and the target content is content that meets the preset detection condition.

The preset detection condition may be understood as a condition that content finally detected in the code to be detected needs to meet, that is, the preset detection condition may be used to indicate the condition that the content finally detected needs to meet. In this case, performing code detection on the code to be detected is to obtain code content in the code to be detected that meets the preset detection condition. The target content may be understood as the code content detected in the code to be detected that meets the preset detection condition. For example, assuming that the preset detection condition is detecting a statement that calls a method, the target content may be a statement that calls the method in the code to be detected. Assuming that the preset detection condition is detecting a method that starts with a specific letter, the target content may be a method that starts with the letter in the code to be detected.

Specifically, the class information of the code to be detected may be detected based on the preset detection condition to determine content in the code to be detected that meets the preset detection condition, that is, to determine the target content in the code to be detected.

S204: Obtain location information of the target content in the code to be detected.

In this embodiment, after the target content of the code to be detected is determined, the location information of the target content in the code to be detected may be further obtained, for example, the line number corresponding to the target content in the code to be detected may be further obtained.

S205: Generate a detection result including the location information as a detection result of the code to be detected.

For example, after the location information of the target content in the code to be detected is obtained, a detection result including the location information may be generated as the detection result of the code to be detected. The generated detection result may or may not include the target content of the code to be detected and/or identification information of the target content. Taking the case that target content and/or the identification information of the target content are/is included as an example, the generated detection result may correspondingly records location information of each piece of target content, and the target content and/or identification information of the target content, which may be specifically set as needed.

S206: Report the detection result to a server, where the reported detection result is used by the server to determine the target content in the code to be detected and process the target content.

In this embodiment, the detection result may be reported to the server after the detection result is generated. Therefore, the server may process, based on the detection result of the code to be detected, the target content in the code to be detected, for example, modify or intercept the target content in the code to be detected, which may be flexibly set as needed.

In some optional embodiments, an execution process of the code detection method provided in this embodiment can be described as follows.

Taking the common Java language as an example, in Java, classloader (i.e., a class loader) of a system may be used as a class loading source, to obtain a class to be detected. In addition, Guava and Reflections also have corresponding class loaders. Taking Guava as an example, the class to be detected may be obtained through APIs such as getTopLevelClasses( ), getTopLevelClasses(String packageName) and/or getTopLevelClassesRecursive(String packageName) of ClassPath (i.e., a class loader).

The class to be detected may be analyzed after the class to be detected is obtained. The analysis method is not limited. This embodiment is illustrated by two methods, Java reflection API and ASM.

In some implementations, analysis may be performed using a Java reflection API. Java provides many APIs to obtain class objects and methods. After the class to be detected is obtained through the above class loader, the API may be used to detect whether each member and method in the class is reasonable (that is, determine whether the target content in the code to be detected meets the preset detection condition). For example, getDeclaredField( ) may be used to obtain a specified attribute of a class, getField( ) may be used to obtain specified attributes of a class and its parent class, getDeclaredFields( ) may be used to obtain all attributes of a class, and getFields( ) may be used to obtain all attributes of a class and its parent class; getDeclaredMethod( ) may be used to obtain a specified method of a class, getMethod( ) may be used to obtain specified methods of a class and its parent class, getDeclaredMethods( ) may be used to obtain all methods of a class, and getMethods( ) may be used to obtain all methods of a class and its parent class; getDeclaredConstructor( ) may be used to obtain a specified constructor of a class, getConstructor( ) may be used to obtain specified constructors of a class and its parent class, getDeclaredConstructors( ) may be used to obtain all constructors of a class, and getConstructors( ) may be used to obtain all constructors of a class and its parent class, and so on.

For example, for detection of all methods named starting with m (i.e., a preset detection condition), a binary file of code to be detected may be read through a class loader, to obtain class information of a class to be detected in the code to be detected. The class information of the class to be detected is read to obtain method information of each class to be detected. Based on this method information, methods in the class to be detected are filtered to obtain methods named starting with the letter m, and the detection result of the code to be detected is generated based on the filtered methods and/or location information of the filtered methods in the code to be detected, and is reported to the server.

In some implementations, a class file (i.e., a binary code file) in the class loader may be read and analyzed through ASM. ASM is a bytecode (i.e., a binary code) modification tool. ASM allows bytecode files to be input and analyzed, while the class loader can be used to determine an executable file that enables the currently loaded or running class to run (usually Java uses class files as executable files of the jvm runtime). After the obtained class information of the class to be detected is analyzed, bytecode detection may be performed through methods such as visitClass, visitMethod, and/or visitField provided by ASM.

For example, for detection of a statement (i.e. a preset detection condition) that calls the method SensitiveApi in the bar method of the Foo class, the structural information of the Foo class may be read first using the ClassReader of ASM. Each call of the bar method and a method body is obtained through APIs such as methods and/or instructions of ASM, and a statement that is a method call is filtered. Then, it is detected whether an owner of the statement is SensitiveApi. If the owner is SensitiveApi, the statement is determined as a statement to be detected, that is, the target content. A detection result of the code to be detected is generated based on the filtered statement and/or location information of the filtered statement in the code to be detected, and is reported to the server.

The code detection method provided in this embodiment can be used to overcome the problem of inconsistency between a detection environment and an actual compilation environment of code in a conventional static detection method, and improve the comprehensiveness and accuracy of code detection results.

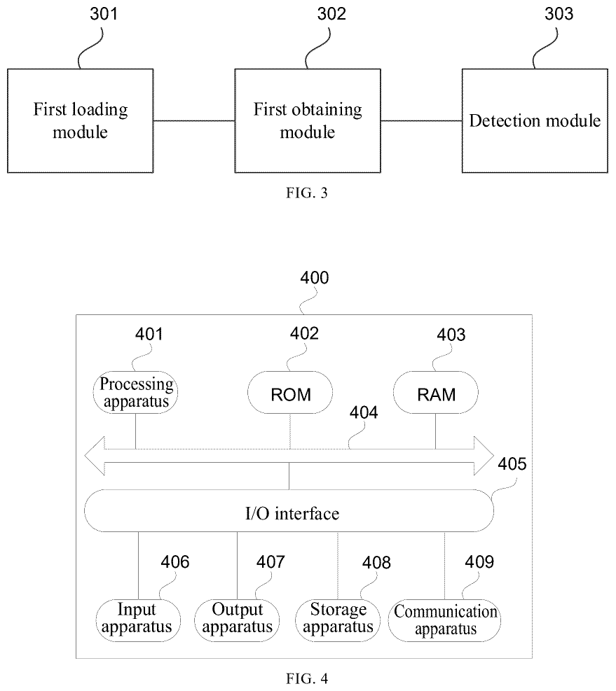

FIG. 3 is a block diagram of a structure of a code detection apparatus according to an embodiment of the present disclosure. The apparatus may be implemented by software and/or hardware, and may be configured in an electronic device, typically, in a computer, and can perform code detection by performing a code detection method, for example, perform static detection on code based on a code reflection mechanism. As shown in FIG. 3, the code detection apparatus provided in this embodiment may include: a first loading module 301, a first obtaining module 302, and a detection module 303.

The first loading module 301 is configured to load code to be detected.

The first obtaining module 302 is configured to obtain, through a class loader, first class information of the code to be detected.

The detection module 303 is configured to perform code detection on the code to be detected based on class information of the code to be detected, to obtain a detection result of the code to be detected, where the class information includes the first class information.

The code detection apparatus provided in this embodiment loads, by using the first loading module, the code to be detected; obtains, by using the first obtaining module through the class loader, the first class information of the code to be detected; and performs, by using the detection module, the code detection on the code to be detected based on the class information of the code to be detected, to obtain the detection result of the code to be detected, where the class information includes the first class information. In this embodiment, the above technical solution can be used, in which the class information of the code to be detected is obtained through the class loader to perform the code detection on the code to be detected, to overcome the problem of inconsistency between a detection environment and an actual compilation environment of code in a conventional static detection method, and improve the comprehensiveness and accuracy of code detection results.

Optionally, the detection module 303 includes: a content determining unit configured to parse, based on a preset detection condition, the class information of the code to be detected, to determine target content in the code to be detected, where the target content is content that meets the preset detection condition; an information obtaining unit configured to obtain location information of the target content in the code to be detected; and a result generating unit configured to generate a detection result including the location information as the detection result of the code to be detected.

Optionally, the first obtaining module 302 may be configured to: generate, through the class loader, a binary code file corresponding to the code to be detected, where the binary code file is used to record the first class information of the code to be detected in a binary code form.

Further, the code detection apparatus provided in this embodiment may further include: a second loading module configured to load the binary code file into a memory after the first class information of the code to be detected is obtained through the class loader; and a content parsing module configured to read file content of the binary code file and parse the file content to obtain the first class information of the code to be detected.

Optionally, the content parsing module may be configured to: read, based on a reflection mechanism, the file content of the binary code file by using an application programming interface corresponding to the reflection mechanism, and parse the file content to obtain the first class information of the code to be detected; or read the file content of the binary code file by using a preset binary code modification tool, and parse the file content to obtain the first class information of the code to be detected.

Optionally, the first loading module 301 may include: a file obtaining unit configured to obtain an executable file of the code to be detected, where the executable file records code content of the code to be detected; and a loading unit configured to load the code content of the code to be detected into the memory.

Optionally, the class information further includes second class information, and the second class information and the first class information are obtained in different manners.

Further, the code detection apparatus provided in this embodiment may further include: a second obtaining module configured to, before the code detection is performed on the code to be detected based on the class information of the code to be detected, obtain a source code file of the code to be detected, and generate an abstract syntax tree corresponding to the source code file; and a syntax tree parsing module configured to parse the abstract syntax tree to obtain the second class information of the code to be detected.

Further, the code detection apparatus provided in this embodiment may further include: a result reporting module configured to report the detection result to a server after the detection result of the code to be detected is obtained, where the reported detection result is used by the server to determine the target content in the code to be detected and process the target content.

The code detection apparatus provided in this embodiment of the present disclosure can perform the code detection method provided in any one of the embodiments of the present disclosure, and has corresponding functional modules and beneficial effects for performing the code detection method. For technical details not described in detail in this embodiment, reference may be made to the code detection method provided in any one of the embodiments of the present disclosure.

FIG. 4 is a schematic diagram of a structure of an electronic device (for example, a terminal device) 400 suitable for implementing the embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 4 is merely an example, and shall not impose any limitation on the function and scope of use of the embodiments of the present disclosure.

As shown in FIG. 4, the electronic device 400 may include a processing apparatus (e.g., a central processing unit or a graphics processing unit) 401 that may perform a variety of appropriate actions and processing in accordance with a program stored in a read-only memory (ROM) 402 or a program loaded from a storage apparatus 408 into a random access memory (RAM) 403. The RAM 403 further stores various programs and data required for the operation of the electronic device 400. The processing apparatus 401, the ROM 402, and the RAM 403 arc connected to each other through a bus 404. An input/output (I/O) interface 405 is also connected to the bus 404.

Generally, the following apparatuses may be connected to the I/O interface 405: an input apparatus 406 including, for example, a touchscreen, a touchpad, a keyboard, a mouse, a camera, a microphone, an accelerometer, and a gyroscope; an output apparatus 407 including, for example, a liquid crystal display (LCD), a speaker, and a vibrator; the storage apparatus 408 including, for example, a tape and a hard disk; and a communication apparatus 409. The communication apparatus 409 may allow the electronic device 400 to perform wireless or wired communication with other devices to exchange data. Although FIG. 4 shows the electronic device 400 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 409 and installed, installed from the storage apparatus 408, or installed from the ROM 402. When the computer program is executed by the processing apparatus 401, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: load code to be detected; obtain, through a class loader, first class information of the code to be detected; and perform code detection on the code to be detected based on class information of the code to be detected, to obtain a detection result of the code to be detected, where the class information includes the first class information.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may alternatively occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a module does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, Example 1 provides a code detection method. The method includes:
loading code to be detected;
obtaining, through a class loader, first class information of the code to be detected; and
performing code detection on the code to be detected based on class information of the code to be detected, to obtain a detection result of the code to be detected, where the class information includes the first class information.

According to one or more embodiments of the present disclosure, Example 2 provides the method according to Example 1, where the performing code detection on the code to be detected based on class information of the code to be detected, to obtain a detection result of the code to be detected includes:
parsing, based on a preset detection condition, the class information of the code to be detected, to determine target content in the code to be detected, where the target content is content that meets the preset detection condition;
obtaining location information of the target content in the code to be detected; and
generating a detection result including the location information as the detection result of the code to be detected.

According to one or more embodiments of the present disclosure, Example 3 provides the method according to Example 1, where the obtaining, through a class loader, first class information of the code to be detected includes:
generating, through the class loader, a binary code file corresponding to the code to be detected, where the binary code file is used to record the first class information of the code to be detected in a binary code form.

According to one or more embodiments of the present disclosure, Example 4 provides the method according to Example 3, where after the obtaining, through a class loader, first class information of the code to be detected, the method further includes:
loading the binary code file into a memory; and
reading file content of the binary code file and parsing the file content to obtain the first class information of the code to be detected.

According to one or more embodiments of the present disclosure, Example 5 provides the method according to Example 4, where the reading file content of the binary code file and parsing the file content to obtain the first class information of the code to be detected includes:
reading, based on a reflection mechanism, the file content of the binary code file by using an application programming interface corresponding to the reflection mechanism, and parsing the file content to obtain the first class information of the code to be detected; or
reading the file content of the binary code file by using a preset binary code modification tool, and parsing the file content to obtain the first class information of the code to be detected.

According to one or more embodiments of the present disclosure, Example 6 provides the method according to Example 1, where the loading code to be detected includes:
obtaining an executable file of the code to be detected, where the executable file records code content of the code to be detected; and
loading the code content of the code to be detected into a memory.

According to one or more embodiments of the present disclosure, Example 7 provides the method according to any one of Examples 1 to 6, where the class information further includes second class information, and the second class information and the first class information are obtained in different manners.

According to one or more embodiments of the present disclosure, Example 8 provides the method according to Example 7, where before the performing code detection on the code to be detected based on class information of the code to be detected, the method further includes:
obtaining a source code file of the code to be detected, and generating an abstract syntax tree corresponding to the source code file; and parsing the abstract syntax tree to obtain the second class information of the code to be detected.

According to one or more embodiments of the present disclosure, Example 9 provides the method according to any one of Examples 1 to 6, where after the obtaining a detection result of the code to be detected, the method further includes:
reporting the detection result to a server, where the reported detection result is used by the server to determine the target content in the code to be detected and process the target content.

According to one or more embodiments of the present disclosure, Example 10 provides a code detection apparatus. The apparatus includes:
a first loading module configured to load code to be detected;
a first obtaining module configured to obtain, through a class loader, first class information of the code to be detected; and
a detection module configured to perform code detection on the code to be detected based on class information of the code to be detected, to obtain a detection result of the code to be detected, where the class information includes the first class information.

According to one or more embodiments of the present disclosure, Example 11 provides an electronic device. The electronic device includes:
one or more processors; and
a memory configured to store one or more programs, where
the one or more programs, when executed by the one or more processors, cause the one or more processors to implement the code detection method according to any one of Examples 1 to 9.

According to one or more embodiments of the present disclosure, Example 12 provides a computer-readable storage medium having a computer program stored thereon, where the computer program, when a processor is executed, causes the code detection method according to any one of Examples 1 to 9 to be implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A code detection method, comprising:
loading code to be detected;
obtaining, through a class loader, first class information of the code to be detected; and
performing code detection on the code to be detected based on class information of the code to be detected, to obtain a detection result of the code to be detected, wherein the class information comprises the first class information.

2. The method according to claim 1, wherein the performing the code detection on the code to be detected based on the class information of the code to be detected, to obtain the detection result of the code to be detected comprises:
parsing, based on a preset detection condition, the class information of the code to be detected, to determine target content in the code to be detected, wherein the target content is content that meets the preset detection condition;
obtaining location information of the target content in the code to be detected; and
generating the detection result comprising the location information as the detection result of the code to be detected.

3. The method according to claim 1, wherein the obtaining, through the class loader, the first class information of the code to be detected comprises:
generating, through the class loader, a binary code file corresponding to the code to be detected, wherein the binary code file is used to record the first class information of the code to be detected in a binary code form.

4. The method according to claim 3, wherein after the obtaining, through the class loader, the first class information of the code to be detected, the method further comprises:
loading the binary code file into a memory; and
reading file content of the binary code file and parsing the file content to obtain the first class information of the code to be detected.

5. The method according to claim 4, wherein the reading the file content of the binary code file and parsing the file content to obtain the first class information of the code to be detected comprises:
reading, based on a reflection mechanism, the file content of the binary code file by using an application programming interface corresponding to the reflection mechanism, and parsing the file content to obtain the first class information of the code to be detected; or
reading the file content of the binary code file by using a preset binary code modification tool, and parsing the file content to obtain the first class information of the code to be detected.

6. The method according to claim 1, wherein the loading code to be detected comprises:
obtaining an executable file of the code to be detected, wherein the executable file records code content of the code to be detected; and
loading the code content of the code to be detected into a memory.

7. The method according to claim 1, wherein the class information further comprises second class information, and the second class information and the first class information are obtained in different manners.

8. The method according to claim 7, wherein before the performing the code detection on the code to be detected based on the class information of the code to be detected, the method further comprises:
obtaining a source code file of the code to be detected, and generating an abstract syntax tree corresponding to the source code file; and
parsing the abstract syntax tree to obtain the second class information of the code to be detected.

9. The method according to claim 1, wherein after the obtaining the detection result of the code to be detected, the method further comprises:
reporting the detection result to a server, wherein the reported detection result is used by the server to determine target content in the code to be detected and process the target content.

10. An electronic device, comprising:
at least one processor; and
a memory communicatively connected to the at least one processor, wherein
the memory stores a computer program executable by the at least one processor, and the computer program, when executed by the at least one processor, causes the at least one processor to:
load code to be detected;
obtain, through a class loader, first class information of the code to be detected; and
perform code detection on the code to be detected based on class information of the code to be detected, to obtain a detection result of the code to be detected, wherein the class information comprises the first class information.

11. The electronic device according to claim 10, wherein the at least one processor is caused to perform the code detection on the code to be detected based on the class information of the code to be detected, to obtain the detection result of the code to be detected by being caused to:
parse, based on a preset detection condition, the class information of the code to be detected, to determine target content in the code to be detected, wherein the target content is content that meets the preset detection condition;
obtain location information of the target content in the code to be detected; and
generate the detection result comprising the location information as the detection result of the code to be detected.

12. The electronic device according to claim 10, wherein the at least one processor is caused to obtain, through the class loader, the first class information of the code to be detected by being caused to:
generate, through the class loader, a binary code file corresponding to the code to be detected, wherein the binary code file is used to record the first class information of the code to be detected in a binary code form.

13. The electronic device according to claim 12, wherein after obtaining, through the class loader, the first class information of the code to be detected, the at least one processor is further caused to:
load the binary code file into the memory; and
read file content of the binary code file and parse the file content to obtain the first class information of the code to be detected.

14. The electronic device according to claim 13, wherein the at least one processor is caused to read the file content of the binary code file and parse the file content to obtain the first class information of the code to be detected by being caused to:
read, based on a reflection mechanism, the file content of the binary code file by using an application programming interface corresponding to the reflection mechanism, and parse the file content to obtain the first class information of the code to be detected; or
read the file content of the binary code file by using a preset binary code modification tool, and parse the file content to obtain the first class information of the code to be detected.

15. The electronic device according to claim 10, wherein the at least one processor is caused to load the code to be detected by being caused to:
obtain an executable file of the code to be detected, wherein the executable file records code content of the code to be detected; and
load the code content of the code to be detected into the memory.

16. The electronic device according to claim 10, wherein the class information further comprises second class information, and the second class information and the first class information are obtained in different manners.

17. The electronic device according to claim 16, wherein before performing the code detection on the code to be detected based on the class information of the code to be detected, the at least one processor is further caused to:
obtain a source code file of the code to be detected, and generate an abstract syntax tree corresponding to the source code file; and
parse the abstract syntax tree to obtain the second class information of the code to be detected.

18. The electronic device according to claim 10, wherein after obtaining the detection result of the code to be detected, the at least one processor is further caused to:
report the detection result to a server, wherein the reported detection result is used by the server to determine target content in the code to be detected and process the target content.

19. A non-transitory computer-readable storage medium, storing computer instructions that, when a processor is executed, implement:
loading code to be detected;
obtaining, through a class loader, first class information of the code to be detected; and
performing code detection on the code to be detected based on class information of the code to be detected, to obtain a detection result of the code to be detected, wherein the class information comprises the first class information.

20. The non-transitory computer-readable storage medium according to claim 19, wherein the performing the code detection on the code to be detected based on the class information of the code to be detected, to obtain the detection result of the code to be detected comprises:
parsing, based on a preset detection condition, the class information of the code to be detected, to determine target content in the code to be detected, wherein the target content is content that meets the preset detection condition;
obtaining location information of the target content in the code to be detected; and
generating the detection result comprising the location information as the detection result of the code to be detected.
